(19) United States
(12) Patent Application Publication
(10) Pub. No.: US 2026/0348022 A1
(43) Pub. Date: Nov. 5, 2026

(54) WATER ELECTROLYSIS SYSTEM INCLUDING HYDROGEN REMOVAL DEVICE AND OXYGEN REMOVAL DEVICE

(71) Applicant: THEEN CO., LTD., Daejeon (KR)

(72) Inventors: Sung Tak KIM, Daejeon (KR); Tae Jun KIM, Daejeon (KR)

(21) Appl. No.: 19/710,313

(22) Filed: Jun. 16, 2026

Related U.S. Application Data
(63) Continuation-in-part of application No. PCT/KR2024/007039, filed on May 24, 2024.

(30) Foreign Application Priority Data
Dec. 18, 2023 (KR) 10-2023-0184779

(51) Int. Cl. C25B 1/04; C25B 11/061; C25B 11/081; C25B 15/08

(52) U.S. Cl. CPC C25B 1/04; C25B 11/061; C25B 11/081; C25B 15/083

(57) ABSTRACT

Proposed is a water electrolysis system including a water electrolysis device, a hydrogen (H₂) removal device, and an oxygen (O₂) removal device. The hydrogen (H₂) removal device removes hydrogen (H₂) from an oxygen (O₂) stream, and the oxygen (O₂) removal device removes oxygen (O₂) from a hydrogen (H₂) stream. By removing hydrogen (H₂) and oxygen (O₂), respectively, from each gas stream, a possibility of an explosion accident during movement of the gas stream may be significantly reduced, and purity requirements for various industrial gases may be satisfied without a separate purification process.

### CROSS REFERENCE TO RELATED APPLICATION

This application is a Bypass Continuation-In-Part of International Patent Application No. PCT/KR2024/007039, filed on May 24, 2024, which claims priority and the benefit of Korean Patent Application No. 10-2023-0184779, filed on Dec. 18, 2023, each of which is hereby incorporated by reference for all purposes as if fully set forth herein.

### BACKGROUND

### Technical Field

The present disclosure relates to a water electrolysis system including a hydrogen removal device and an oxygen removal device.

### Description of the Related Art

Recently, as depletion of fossil fuel, the most widely used energy source on Earth, and environmental pollution have rapidly emerged as critical concerns, research related thereto has been conducted in various fields in order to produce green hydrogen by combining renewable energy which is an energy source replacing the fossil fuel with a water electrolysis process.

However, since the renewable energy generally provides intermittent and low power, there is a problem in that purity of finally produced hydrogen is low, oxygen is mixed with the hydrogen, and the hydrogen easily reaches an explosion limit.

In addition, since hydrogen lowers purity and increases a possibility of ignition and explosion even in an oxygen stream generated from a water electrolysis process, a method for increasing the purity of each of hydrogen and oxygen which are reaction products is essentially required in order to secure safety of a water electrolysis system.

Therefore, in the present disclosure, stability of a water electrolysis system is intended to be increased by removing oxygen in a hydrogen stream and removing hydrogen in an oxygen stream.

### DOCUMENT OF RELATED ART

(Patent Document 1) Japanese Unexamined Patent Application Publication No. 2018/096713 (May 31, 2018)
(Patent Document 2) Japanese Patent No. 7136919 (Sep. 5, 2022)
(Patent Document 3) Japanese Patent No. 3091389 (Jul. 21, 2000)

### SUMMARY

Accordingly, the present disclosure has been made keeping in mind the above problems occurring in the related art, and an objective of the present disclosure is to provide a water electrolysis system including a hydrogen removal device and an oxygen removal device.

The present disclosure relates to a water electrolysis system including a water electrolysis device, a hydrogen (H₂) removal device, and an oxygen (O₂) removal device, and the water electrolysis device may include an oxidation electrode (anode) and a reduction electrode (cathode).

The hydrogen (H₂) removal device may be configured to remove hydrogen (H₂) from an oxygen (O₂) stream generated from the oxidation electrode (anode) of the water electrolysis device, and the oxygen (O₂) removal device may be configured to remove oxygen (O₂) from a hydrogen (H₂) stream generated from the reduction electrode (cathode) of the water electrolysis device.

The hydrogen (H₂) removal device and the oxygen (O₂) removal device may each include a catalyst.

The catalyst may include a catalytic metal and a support.

The catalytic metal may be at least one selected from palladium (Pd), platinum (Pt), nickel (Ni), silver (Ag), gold (Au), manganese (Mn), iron (Fe), cobalt (Co), zinc (Zn), ruthenium (Ru), rhodium (Rh), osmium (Os), iridium (Ir), lutetium (Lu), gallium (Ga), indium (In), bismuth (Bi), molybdenum (Mo), gadolinium (Gd), titanium (Ti), and copper (Cu).

The support may be at least one selected from the group consisting of oxides of aluminum (Al), cerium (Ce), manganese (Mn), indium (In), iridium (Ir), gallium (Ga), thallium (Tl), zinc (Zn), titanium (Ti), and yttrium (Y).

A content of the catalytic metal in the catalyst may be 0.01 wt % to 30 wt %.

The hydrogen (H₂) removal device may remove 99% or more of hydrogen (H₂) molecules from the oxygen (O₂) stream.

The oxygen (O₂) removal device may remove 99.99% or more of oxygen (O₂) molecules from the hydrogen (H₂) stream.

In the hydrogen (H₂) removal device, the hydrogen (H₂) molecules may be removed from the oxygen (O₂) stream within three hours.

In the oxygen (O₂) removal device, the oxygen (O₂) molecules may be removed from the hydrogen (H₂) stream within three hours.

The hydrogen (H₂) removal device and the oxygen (O₂) removal device may each include a catalytic reactor, a moisture adsorber, and a wool member.

The water electrolysis system may include a hydrogen (H₂) removal module including a plurality of hydrogen (H₂) removal devices, and may include an oxygen (O₂) removal module including a plurality of oxygen (O₂) removal devices.

The water electrolysis system may include a plurality of hydrogen (H₂) removal devices and oxygen (O₂) removal devices, and while one hydrogen (H₂) removal device and one oxygen (O₂) removal device are in operation, the remaining hydrogen (H₂) removal devices and the remaining oxygen (O₂) removal devices may perform a regeneration reaction of the catalyst.

The water electrolysis system according to the present disclosure has an effect of improving stability by removing hydrogen (H₂) and oxygen (O₂), respectively, from the oxygen (O₂) stream and the hydrogen (H₂) stream generated from the water electrolysis system through a catalytic reaction, so that there is an effect of increasing purity of hydrogen (H₂) and oxygen (O₂).

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a graph showing a change in concentration of hydrogen (H₂) over time when a catalytic reaction for removing hydrogen (H₂) from an oxygen (O₂) stream is performed using an embodiment of the present disclosure;

FIG. 2 is a graph showing a change in concentration of hydrogen (H₂) over time when a catalytic reaction for removing hydrogen (H₂) from an oxygen (O₂) stream is performed using an embodiment of the present disclosure;

FIG. 3 is a graph showing a change in concentration of hydrogen (H₂) over time when a catalytic reaction for removing hydrogen (H₂) from an oxygen (O₂) stream is performed using an embodiment of the present disclosure;

FIG. 4 is a graph showing a change in concentration of hydrogen (H₂) over time when a catalytic reaction for removing hydrogen (H₂) from an oxygen (O₂) stream is performed using an embodiment of the present disclosure;

FIG. 5 is a graph showing a change in concentration of hydrogen (H₂) over time when a catalytic reaction for removing hydrogen (H₂) from an oxygen (O₂) stream is performed using an embodiment of the present disclosure;

FIG. 6 is a graph showing a change in concentration of oxygen (O₂) over time when a catalytic reaction for removing oxygen (O₂) from a hydrogen (H₂) stream is performed using an embodiment of the present disclosure;

FIG. 7 is a graph showing a change in concentration of oxygen (O₂) over time when a catalytic reaction for removing oxygen (O₂) from a hydrogen (H₂) stream is performed using an embodiment of the present disclosure;

FIG. 8 is a graph showing a change in concentration of oxygen (O₂) over time when a catalytic reaction for removing oxygen (O₂) from a hydrogen (H₂) stream is performed using an embodiment of the present disclosure;

FIG. 9 is a graph showing a change in concentration of oxygen (O₂) over time when a catalytic reaction for removing oxygen (O₂) from a hydrogen (H₂) stream is performed using an embodiment of the present disclosure; and

FIG. 10 is a graph showing a change in concentration of oxygen (O₂) over time when a catalytic reaction for removing oxygen (O₂) from a hydrogen (H₂) stream is performed using an embodiment of the present disclosure.

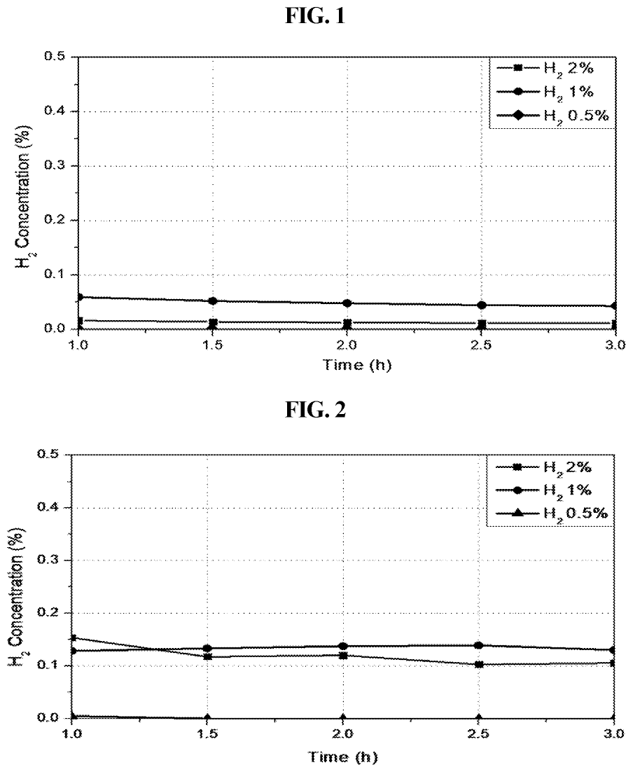

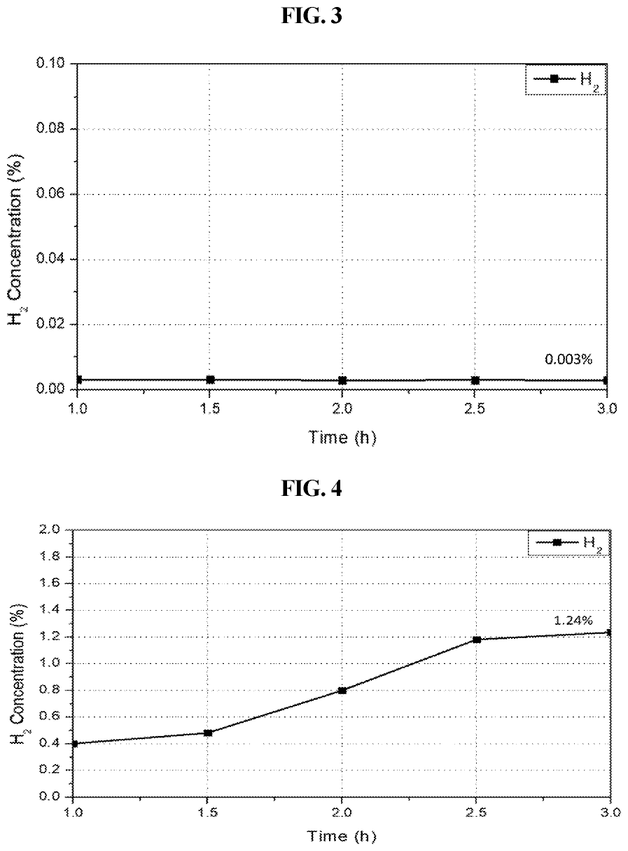

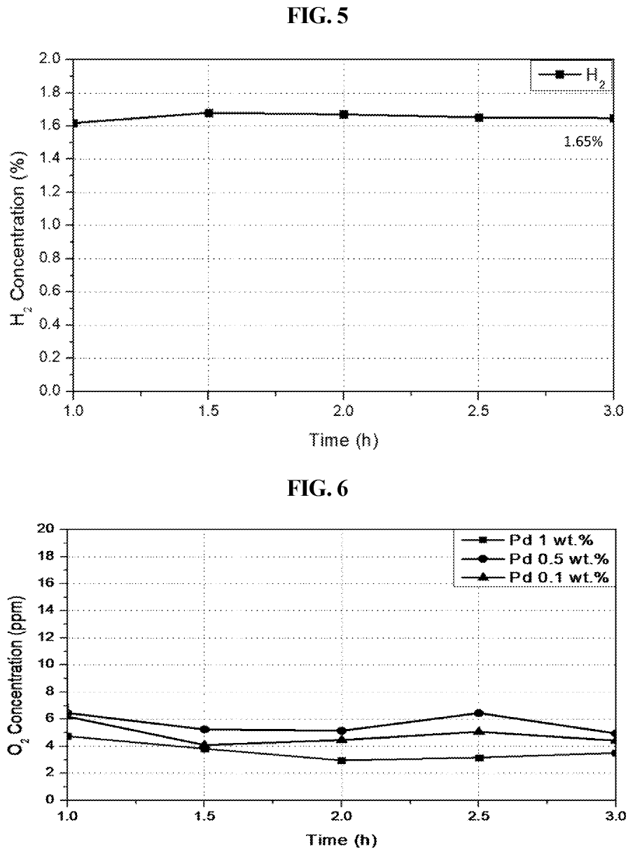

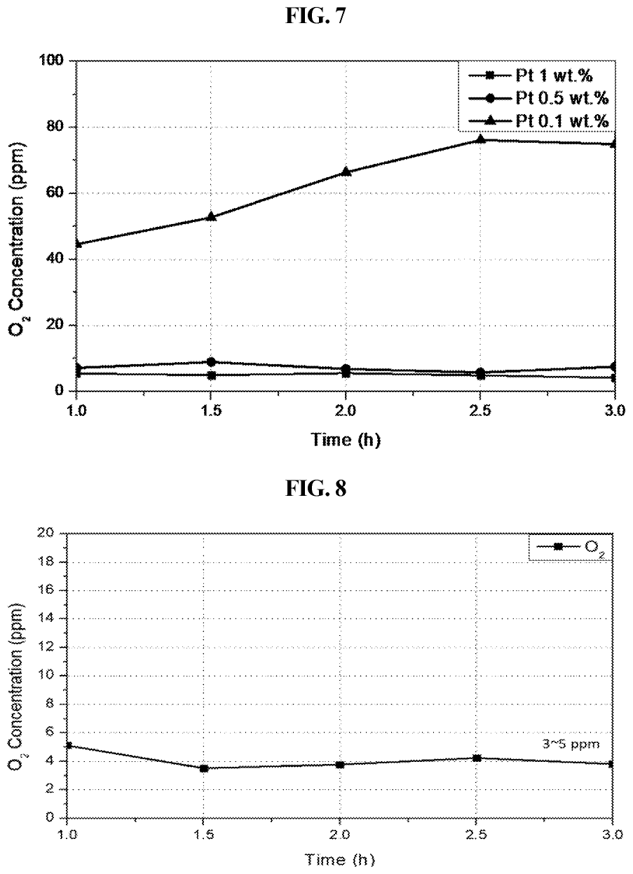

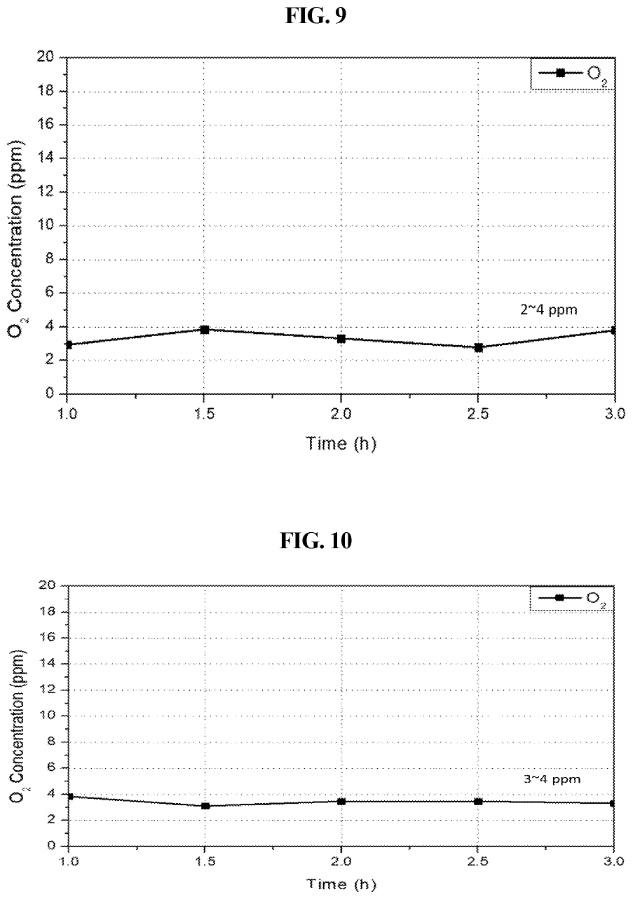

### DETAILED DESCRIPTION

Hereinafter, a water electrolysis system including a hydrogen removal device and an oxygen removal device according to the present disclosure will be described in detail. The drawings introduced below are provided as examples so that the scope of the present disclosure can be sufficiently conveyed to those skilled in the art. Therefore, the present disclosure is not limited to the drawings presented below and may be embodied in other forms, and the drawings presented below may be exaggerated to clarify the scope of the present disclosure. Here, unless technical terms and scientific terms used in the present disclosure are otherwise defined, the technical terms and scientific terms have meanings generally understood by those of ordinary skill in the art to which the present disclosure pertains, and descriptions of known functions and configurations that may unnecessarily obscure the gist of the present disclosure in the following description and the accompanying drawings will be omitted.

The present disclosure relates to a water electrolysis system including a water electrolysis device; a hydrogen (H₂) removal device; and an oxygen (O₂) removal device, and the water electrolysis device may include an oxidation electrode (anode) and a reduction electrode (cathode). Oxygen may be generated at the oxidation electrode (anode) according to Chemical Reaction Formula 1 below, and hydrogen (H₂) may be generated at the reduction electrode (cathode) according to Chemical Reaction Formula 2 below.

4OH⁻(aq)→O₂(g)+2H₂O+4e⁻ [Chemical Reaction Formula 1]

2H₂O+2e⁻→H₂(g)+2OH⁻(aq) [Chemical Reaction Formula 2]

The type of the water electrolysis device is not particularly limited, and any water electrolysis device generally used in the art may be used without limitation. Examples of such a water electrolysis device may include an alkaline water electrolysis device, a cation exchange membrane water electrolysis device, an anion exchange membrane water electrolysis device, and so on.

As reactions described in Chemical Reaction Formulas 1 and 2 occur at the oxidation electrode (anode) and the reduction electrode (cathode), respectively, an oxygen (O₂) stream and a hydrogen (H₂) stream are generated, respectively. Here, each stream has a purity of 99.9% or more, but a trace amount of hydrogen (H₂) remains in the oxygen (O₂) stream, and a trace amount of oxygen (O₂) remains in the hydrogen (H₂) stream. The amount is generally known to be equal to or less than 20,000 ppm. However, in order to collect a gas constituting each stream while preventing an explosion accident and use the gas as a power source of a general electronic device, the amount is required to satisfy an industrial standard specified as equal to or less than 200 ppm. Furthermore, in order to use the gas as a power source of a fuel cell for a vehicle, the amount is required to satisfy an industrial standard specified as equal to or less than 5 ppm.

Therefore, an objective of the water electrolysis system provided in the present disclosure is to increase purity of the stream by using the hydrogen (H₂) removal device and the oxygen (O₂) removal device. More specifically, the hydrogen (H₂) removal device may remove hydrogen (H₂) from the oxygen (O₂) stream generated from the oxidation electrode (anode) of the water electrolysis device, and the oxygen (O₂) removal device may remove oxygen (O₂) from the hydrogen (H₂) stream generated from the reduction electrode (cathode) of the water electrolysis device.

The hydrogen (H₂) removal device and the oxygen (O₂) removal device may each include a catalyst. The catalyst may include a catalytic metal and a support. Specifically, the catalyst may be formed by supporting catalytic metal particles on the support, and the catalytic metal may be at least one selected from palladium (Pd), platinum (Pt), nickel (Ni), silver (Ag), gold (Au), manganese (Mn), iron (Fe), cobalt (Co), zinc (Zn), ruthenium (Ru), rhodium (Rh), osmium (Os), iridium (Ir), lutetium (Lu), gallium (Ga), indium (In), bismuth (Bi), molybdenum (Mo), gadolinium (Gd), titanium (Ti), and copper (Cu). Preferably, palladium (Pd) and platinum (Pt) may be used alone, or a mixed catalytic metal such as palladium-nickel (Pd—Ni) or platinum-nickel (Pt—Ni) may be used.

The content of the catalytic metal in the catalyst may be 0.01 wt % to 30 wt %, and a remainder may be formed of the support. Here, the catalyst of the hydrogen (H₂) removal device preferably has a catalytic metal content of 0.03 wt % to 10 wt %, and more preferably 0.1 wt % to 10 wt %. The catalyst used in the hydrogen (H₂) removal device may have higher hydrogen removal performance as the content of the catalytic metal decreases within the above-described range. Particularly, the hydrogen removal performance may be maximized when the content of the catalytic metal is 0.1 wt % to 10 wt %. In addition, palladium (Pd), platinum (Pt), and nickel (Ni) are preferably used as the catalytic metal used in the catalyst of the hydrogen (H₂) removal device, palladium (Pd) and platinum (Pt) are preferably used when the catalytic metal is used as a single element, and palladium (Pd) and nickel (Ni) are preferably used when the catalytic metal is used as a mixture. Here, when palladium (Pd) and nickel (Ni) are mixed, a hydrogen removal rate is significantly high at 99.85% or more, and a rate of a removal reaction is remarkably increased, thereby providing an effect of removing a maximum amount of hydrogen within one hour. A mixing ratio of palladium (Pd) and nickel (Ni) is not particularly limited, but is preferably adjusted within a range of 1:0.25 to 1:0.75. Furthermore, in the case of palladium (Pd) and platinum (Pt) used as single elements, hydrogen removal rates may be high at 99.45% or more and 94.70% or more, respectively, but a removal reaction proceeds slightly more slowly than with the above-described mixed catalytic metal of palladium (Pd) and nickel (Ni), so that a maximum amount of hydrogen may be removed within three hours.

Meanwhile, the catalyst of the oxygen (O₂) removal device may preferably have a catalytic metal content of 0.01 wt % to 10 wt %, and more preferably 0.03 wt % to 5 wt %. The catalyst used in the oxygen (O₂) removal device may have higher oxygen removal performance as the content of the catalytic metal increases within the above-described range. Particularly, the oxygen removal performance may be maximized when the content of the catalytic metal is 0.03 wt % to 5 wt %.

In addition, the support may be at least one selected from the group consisting of oxides of aluminum (Al), cerium (Ce), and yttrium (Y). In the case of the support, the support has a smaller effect on catalytic performance than the catalytic metal, but there may be a difference in a degree of dispersing the catalytic metal particles, and a performance change may occur accordingly.

Specifically, in the case of the catalyst used in the hydrogen (H₂) removal device, hydrogen removal performance may be maximized particularly when aluminum oxide (Al₂O₃) is used as the support. However, when cerium oxide (CeO₂) and yttrium oxide (Y₂O₃) are applied as the support to the hydrogen (H₂) removal device, removal of hydrogen may be difficult to be performed, so that cerium oxide (CeO₂) and yttrium oxide (Y₂O₃) are not preferable compared to aluminum oxide (Al₂O₃).

In addition, in the case of the oxygen (O₂) removal device, aluminum oxide (Al₂O₃) may have somewhat lower oxygen (O₂) removal performance within one hour, but may exhibit removal performance at a level similar to cerium oxide (CeO₂) and yttrium oxide (Y₂O₃) from a time point at which 1.5 hours to 2.0 hours have elapsed.

The hydrogen (H₂) removal device may remove 99% or more of hydrogen (H₂) molecules from the oxygen (O₂) stream. A removal rate of hydrogen (H₂) is greatly affected by an initial hydrogen (H₂) concentration. Furthermore, when the initial hydrogen (H₂) concentration is 2.0% or less, the hydrogen (H₂) concentration may reach 200 ppm or less within one hour after a catalytic reaction for removing hydrogen (H₂) starts and may reach 150 ppm or less within two hours. Furthermore, when the initial hydrogen (H₂) concentration is 0.5% or less, the hydrogen (H₂) concentration may reach 50 ppm or less within one hour, and the hydrogen (H₂) molecules may be completely removed within two hours.

The oxygen (O₂) removal device may remove 99.99% or more of oxygen (O₂) molecules from the hydrogen (H₂) stream. Unlike the removal rate of hydrogen (H₂), a removal rate of oxygen (O₂) is not greatly affected by an initial concentration of oxygen (O₂), and is more greatly affected by the content of the catalytic metal in the catalyst. When the content of the catalytic metal in the catalyst of the oxygen (O₂) removal device is 1.0 wt % or more, 990 or more of oxygen (O₂) may be removed when 0.5 hours have elapsed. Furthermore, when one hour or more has elapsed, 99.9% or more of oxygen (O₂) may be removed, thereby maintaining the oxygen (O₂) concentration at 5 ppm or less. In addition, when the content of the catalytic metal is equal to or larger than 0.1 wt % and less than 1.0 wt %, 97% or more of oxygen (O₂) may be removed when 0.5 hours have elapsed, and 99.9% or more of oxygen (O₂) may be removed when one hour or more has elapsed, thereby maintaining the oxygen (O₂) concentration at 8 ppm or less. Here, particularly when a mixed catalytic metal such as palladium (Pd)-nickel (Ni) is used or when cerium oxide (CeO₂) or yttrium oxide (Y₂O₃) is used as the support, 99.9% or more of oxygen (O₂) may be removed when 0.5 hours have elapsed, thereby maintaining the oxygen (O₂) concentration at 10 ppm or less.

Therefore, in the hydrogen (H₂) removal device and the oxygen (O₂) removal device, a gas molecule to be removed may be removed from each gas stream within three hours.

The hydrogen (H₂) removal device and the oxygen (O₂) removal device may each include a catalytic reactor, a moisture adsorber, and a wool member. Here, the moisture adsorber may be positioned at a lower end of the catalytic reactor.

The catalytic reactor includes the catalyst, and is a place where a hydrogen (H₂) removal reaction and an oxygen (O₂) removal reaction occur. Moisture generated in the removal reactions of hydrogen (H₂) and oxygen (O₂) may move to a lower end of each removal device by movement caused by gravity and diffusion caused by a concentration difference, may reach the moisture adsorber through the wool member, and may be removed by a desiccant.

In the catalytic reactor and the moisture adsorber, the lower end of the catalytic reactor and an upper end of the moisture adsorber may each have fastening portions that are engaged with each other. The fastening portions may be used for replacing the catalyst or the desiccant when the catalyst or the desiccant is consumed.

The desiccant is not particularly limited as long as the desiccant is a generally used desiccant. For example, the desiccant may be a molecular sieve, silica gel, zeolite, diatomaceous earth, or the like.

The wool member may be formed by gathering a fibrous material, and may include quartz, glass, acrylic fiber, or the like. The wool member may be filled in both end portions of the catalytic reactor and the moisture adsorber.

The hydrogen (H₂) removal device and the oxygen (O₂) removal device may further include a heating member that heats an inner portion of each device. By heating the inside of the hydrogen (H₂) removal device and the oxygen (O₂) removal device, the catalytic reaction may proceed more actively.

The water electrolysis system may include a hydrogen (H₂) removal module including a plurality of hydrogen (H₂) removal devices, and may include an oxygen (O₂) removal module including a plurality of oxygen (O₂) removal devices.

In the hydrogen (H₂) removal module and the oxygen (O₂) removal module of the water electrolysis system, while one hydrogen (H₂) removal device and one oxygen (O₂) removal device are in operation, the remaining hydrogen (H₂) removal devices and the remaining oxygen (O₂) removal devices may perform a regeneration reaction of the catalyst.

The present disclosure may further include: a regeneration gas storage; a regeneration gas supply pipe configured to supply a regeneration gas from the regeneration gas storage to the hydrogen (H₂) removal device and the oxygen (O₂) removal device; and a flow path control device configured to, while one hydrogen (H₂) removal device and one oxygen (O₂) removal device are in operation, block regeneration gas supply flow paths to the operating hydrogen (H₂) removal device and the operating oxygen (O₂) removal device, and connect flow paths so as to supply the regeneration gas to the remaining hydrogen (H₂) removal device and the remaining oxygen (O₂) removal device.

The flow path control device may include: a signal distributor configured to control the hydrogen (H₂) removal module and the oxygen (O₂) removal module so that operation and regeneration are alternately performed in each of the hydrogen (H₂) removal module and the oxygen (O₂) removal module; a first valve configured to activate gas stream supply flow paths to the operating hydrogen (H₂) removal module and the operating oxygen (O₂) removal module and to block gas stream supply flow paths to the remaining hydrogen (H₂) removal module and the remaining oxygen (O₂) removal module; a second valve configured to activate gas stream discharge flow paths from the operating reaction modules and to block gas stream discharge flow paths from the remaining hydrogen (H₂) removal module and the remaining oxygen (O₂) removal module; a third valve configured to block regeneration gas supply flow paths to the operating reaction modules and to activate regeneration gas supply flow paths to the remaining reaction modules; and a fourth valve configured to block regeneration gas discharge flow paths from the operating reaction modules and to activate regeneration gas discharge flow paths from the remaining reaction modules.

The first to fourth valves may be selected and used from a three-way valve or a multi-way valve according to the number of hydrogen (H₂) removal modules and oxygen (O₂) removal modules used. When two hydrogen (H₂) removal modules and two oxygen (O₂) removal modules are provided, a three-way valve is preferably used. Furthermore, when three or more hydrogen (H₂) removal modules and three or more oxygen (O₂) removal modules are provided, a multi-way valve is preferably used.

The first to fourth valves may be controlled by a signal of the signal distributor. Here, the signal distributor may output a signal on the basis of a physical quantity such as time, flow rate, and humidity.

The regeneration gas is used for reducing an oxidized catalytic metal, and the type of the regeneration gas is not particularly limited as long as the regeneration gas generally forms a reducing atmosphere. For example, the regeneration gas may be a mixed gas such as compressed natural gas or purified methane.

Hereinafter, the water electrolysis system including the hydrogen removal device and the oxygen removal device according to the present disclosure will be described in more detail through embodiments. However, the following embodiments are merely one reference for describing the present disclosure in detail, and the present disclosure is not limited thereto and may be implemented in various forms.

In addition, unless otherwise defined, all technical terms and scientific terms have the same meanings as meanings generally understood by one of ordinary skill in the art to which the present disclosure pertains. The terms used in the description herein are merely for effectively describing specific embodiments and are not intended to limit the present disclosure. In addition, a unit of an additive not specifically described in the specification may be wt %.

### [Embodiment 1-1] Pd/Al₂O₃ 1.0 wt %

Palladium chloride (PdCl₂) was dissolved in hydrochloric acid and distilled water, and then the solution was impregnated into an aluminum oxide (Al₂O₃) support. Here, an amount of supported palladium (Pd) was adjusted to be 1.0 wt % on the basis of the total weight of the catalyst, the catalyst was dried in a dryer at 110 degrees Celsius for 24 hours, and then the catalyst was calcined at 350 degrees Celsius for three hours.

### [Embodiment 1-2] Pd/Al₂O₃ 0.5 wt %

All processes were performed in the same manner as in Example 1-1, except that the amount of supported palladium (Pd) was adjusted to be 0.5 wt % on the basis of the total weight of the catalyst.

### [Embodiment 1-3] Pd/Al₂O₃ 0.1 wt %

All processes were performed in the same manner as in Example 1-1, except that the amount of supported palladium (Pd) was adjusted to be 0.1 wt % on the basis of the total weight of the catalyst.

### [Embodiment 2-1] Pt/Al₂O₃ 1.0 wt %

All processes were performed in the same manner as in Example 1-1, except that palladium chloride (PdCl₂) was changed to platinum chloride (PtCl₂).

### [Embodiment 2-2] Pt/Al₂O₃ 0.5 wt %

All processes were performed in the same manner as in Example 2-1, except that an amount of supported platinum (Pt) was adjusted to be 0.5 wt % on the basis of the total weight of the catalyst.

### [Embodiment 2-3] Pt/Al₂O₃ 0.1 wt %

All processes were performed in the same manner as in Example 2-1, except that the amount of supported platinum (Pt) was adjusted to be 0.1 wt % on the basis of the total weight of the catalyst.

### [Embodiment 3] Pd—Ni/Al₂O₃ 0.5-0.5 wt %

All processes were performed in the same manner as in Example 1-1, except that palladium chloride (PdCl₂) and nickel nitrate (Ni(NO₃)₂) were used so that palladium (Pd) in the catalyst was 0.5 wt % and nickel (Ni) in the catalyst was 0.5 wt %.

### [Embodiment 4] Pd/CeO₂ 0.5 wt %

Palladium chloride (PdCl₂) was dissolved in hydrochloric acid and distilled water, and then the solution was impregnated into a cerium oxide (CeO₂) support. Here, an amount of supported palladium (Pd) was adjusted to be 0.5 wt % on the basis of the total weight of the catalyst, the catalyst was dried in a dryer at 110 degrees Celsius for 24 hours, and then the catalyst was calcined at 350 degrees Celsius for three hours.

### [Embodiment 5] Pd/Y₂O₃ 0.5 wt %

All processes were performed in the same manner as in Example 4, except that the support was changed to yttrium oxide (Y₂O₃).

### [Characteristic Evaluation Method]

### A. Evaluation of Hydrogen (H₂) Removal Performance

In order to examine an effect of removing hydrogen (H₂) according to a type of catalyst in an oxygen (O₂) stream, a catalytic reaction was performed at room temperature by adjusting a reactor space velocity to 2,048 GHSV and filling 0.3 g of the catalyst. Here, a sample was collected according to the passage of time during the catalytic reaction, and a hydrogen (H₂) concentration was acquired.

TABLE 1

| | Residual hydrogen concentration (vol. %) | | | | | | | | |
|---|---|---|---|---|---|---|---|---|---|
| Reaction | | | | | | | Embodi- | Embodi- | Embodi- |
| time (hr) | Embodiment 1-2 | | | Embodiment 2-2 | | | ment 3 | ment 4 | ment 5 |
| 0.0 | 2.000 | 1.000 | 0.500 | 2.000 | 1.000 | 0.500 | 2.000 | 2.000 | 2.000 |
| 0.5 | 0.036 | 0.027 | 0 | 0.016 | 0.130 | 0.077 | 0.015 | 0.120 | 0.140 |
| 1.0 | 0.016 | 0.059 | 0 | 0.154 | 0.128 | 0.005 | 0.003 | 0.400 | 1.620 |
| 1.5 | 0.014 | 0.052 | 0 | 0.117 | 0.133 | 0 | 0.003 | 0.480 | 1.680 |
| 2.0 | 0.013 | 0.048 | 0 | 0.120 | 0.137 | 0 | 0.003 | 0.800 | 1.670 |
| 2.5 | 0.012 | 0.044 | 0 | 0.103 | 0.139 | 0 | 0.003 | 1.180 | 1.650 |
| 3.0 | 0.011 | 0.043 | 0 | 0.106 | 0.130 | 0 | 0.003 | 1.240 | 1.650 |

In Table 1, a residual hydrogen (H₂) concentration measured when hydrogen (H₂) was removed from an oxygen (O₂) stream by a catalytic reaction using Embodiments 1-2, 2-2, and 3 to 5 may be confirmed.

Embodiment 1-2 is a catalyst including palladium (Pd) and aluminum oxide (Al₂O₃). When an initial concentration was 2.000 vol. %, hydrogen (H₂) was removed at about 98.2% to 0.036 vol. % within 0.5 hours, about 99.2% of hydrogen (H₂) could be removed when 1.0 hour elapsed, and about 99.45% of hydrogen (H₂) could be removed when 3.0 hours elapsed. Therefore, the catalyst including palladium (Pd) and aluminum oxide (Al₂O₃) could be confirmed to be effective in removing hydrogen (H₂) from the oxygen (O₂) stream.

In addition, when the initial concentration was 0.500 vol. %, hydrogen (H₂) could be confirmed to have been completely removed within 0.5 hours and, accordingly, hydrogen (H₂) was confirmed to be more easily removed as the initial concentration decreased.

Next, Embodiment 2-2 is a catalyst including platinum (Pt) and aluminum oxide (Al₂O₃). When an initial concentration of hydrogen (H₂) was 2.000 vol. %, about 92.3% of hydrogen (H₂) could be removed when 1.0 hour elapsed, and about 94.7% of hydrogen (H₂) could be removed when 3.0 hours elapsed. Therefore, the catalyst including platinum (Pt) and aluminum oxide (Al₂O₃) is effective in removing hydrogen (H₂) from the oxygen (O₂) stream, but the catalyst could be confirmed to have somewhat insufficient performance compared to the catalyst including palladium (Pd).

Here, when the initial concentration was 0.500 vol. %, Embodiment 2-2 was also confirmed to completely remove hydrogen (H₂) within 1.5 hours and, accordingly, similarly to Example 1-2, hydrogen (H₂) was confirmed to be more easily removed as the initial concentration decreased.

Next, Embodiment 3 is a catalyst containing 0.5 wt % of palladium (Pd) and 0.5 wt % of nickel (Ni). When an initial concentration was 2.000 vol. %, about 99.25% of hydrogen (H₂) could be removed when 0.5 hours elapsed, and about 99.85% of hydrogen (H₂) could be removed when 1.0 hour elapsed. That is, in removing hydrogen (H₂) in the oxygen (O₂) stream, the most effective catalyst was Embodiment 3 in which palladium (Pd)-nickel (Ni) were mixed.

Next, Embodiment 4 is a catalyst including palladium (Pd) and cerium oxide (CeO₂). When an initial concentration was 2.000 vol. %, about 80.0% of hydrogen (H₂) could be removed when 1.0 hour elapsed, and about 62.0% of hydrogen (H₂) could be removed when 3.0 hours elapsed. In the case of Embodiment 4, a hydrogen (H₂) concentration was shown to significantly decrease immediately after the catalytic reaction started, but the hydrogen (H₂) concentration thereafter tended to increase again, so that Embodiment 4 was confirmed not to be suitable for removing hydrogen (H₂).

Finally, Embodiment 5 is a catalyst including palladium (Pd) and yttrium oxide (Y₂O₃), and Embodiment 5 showed a tendency of hardly removing hydrogen (H₂), similarly to Example 4, and was confirmed not to be suitable for removing hydrogen (H₂).

### B. Evaluation of Oxygen (O₂) Removal Performance

In order to examine an effect of removing oxygen (O₂) according to a type of catalyst in a hydrogen (H₂) stream, a catalytic reaction was performed at room temperature by adjusting a reactor space velocity to 2,048 GHSV and filling 0.3 g of the catalyst. Here, a sample was collected according to the passage of time during the catalytic reaction, and an oxygen (O₂) concentration was acquired.

TABLE 2

| | Residual oxygen concentration (ppm) | | | | | | | | |
|---|---|---|---|---|---|---|---|---|---|
| Reaction | Embodi- | Embodi- | Embodi- | Embodi- | Embodi- | Embodi- | Embodi- | Embodi- | Embodi- |
| time (hr) | ment 1-1 | ment 1-2 | ment 1-3 | ment 2-1 | ment 2-2 | ment 2-3 | ment 3 | ment 4 | ment 5 |
| 0.0 | 20,000 | 20,000 | 20,000 | 20,000 | 20,000 | 20,000 | 20,000 | 20,000 | 20,000 |
| 0.5 | 144.29 | 415.46 | 614.11 | 5.44 | 5.49 | 49.98 | 5.87 | 10.29 | 8.58 |
| 1.0 | 4.75 | 6.46 | 6.20 | 5.45 | 7.13 | 44.58 | 5.12 | 2.94 | 3.84 |
| 1.5 | 3.82 | 5.25 | 4.09 | 4.92 | 8.92 | 52.73 | 3.52 | 3.86 | 3.10 |
| 2.0 | 2.96 | 5.14 | 4.46 | 5.52 | 6.82 | 66.73 | 3.77 | 3.32 | 3.47 |
| 2.5 | 3.16 | 6.45 | 5.07 | 4.87 | 5.75 | 76.18 | 4.23 | 2.78 | 3.46 |
| 3.0 | 3.51 | 4.95 | 4.41 | 4.14 | 7.49 | 74.92 | 3.81 | 3.81 | 3.32 |

In Table 2, a residual oxygen concentration measured when oxygen was removed from a hydrogen (H₂) stream by a catalytic reaction using the Embodiments may be confirmed.

Embodiments 1-1 to 1-3 are catalysts including palladium (Pd) and aluminum oxide (Al₂O₃). When an initial concentration of oxygen (O₂) was 2,000 ppm, the oxygen (O₂) concentration could be confirmed to decrease to a level of about 5 ppm within 1.0 hour.

Embodiments 2-1 and 2-2 are catalysts including platinum (Pt) and aluminum oxide (Al₂O₃). When the initial concentration of oxygen (O₂) was 2,000 ppm, the oxygen (O₂) concentration could be confirmed to decrease to a level of about 5 ppm to 10 ppm within 0.5 hours. However, Embodiment 2-3 showed poorer performance than Embodiments 2-1 and 2-2, with the oxygen (O₂) concentration remaining at a level of 49.98 ppm to 76.18 ppm over time.

Next, Embodiment 3 is a catalyst containing 0.5 wt % of palladium (Pd) and 0.5 wt % of nickel (Ni). When the initial concentration of oxygen (O₂) was 2,000 ppm, the oxygen (O₂) concentration could be confirmed to decrease to a level of about 6 ppm within 0.5 hours. In addition, after 1.5 hours elapsed, the oxygen (O₂) concentration was shown to be 5 ppm or less and, accordingly, oxygen (O₂) removal performance of Embodiment 3 could be confirmed to be very excellent.

Next, Embodiment 4 is a catalyst including palladium (Pd) and cerium oxide (CeO₂). When the initial concentration of oxygen (O₂) was 2,000 ppm, the oxygen (O₂) concentration could be confirmed to decrease to a level of about 10 ppm within 0.5 hours. In addition, after 1.0 hours elapsed, the oxygen (O₂) concentration was shown to be 5 ppm or less and, accordingly, oxygen (O₂) removal performance of Embodiment 4 could be confirmed to be very excellent.

Finally, Embodiment 5 is a catalyst including palladium (Pd) and yttrium oxide (Y₂O₃). When the initial concentration of oxygen (O₂) was 2,000 ppm, the oxygen (O₂) concentration could be confirmed to decrease to a level of about 10 ppm within 0.5 hours. In addition, after 1.0 hours elapsed, the oxygen (O2) concentration was shown to be 5 ppm or less and, accordingly, oxygen (O₂) removal performance of Embodiment 5 could be confirmed to be very excellent.

### C. Summary of Evaluation Results

TABLE 3

| | Hydrogen removal rate (%) | | | | | | | | |
|---|---|---|---|---|---|---|---|---|---|
| Reaction | | | | | | | Embodi- | Embodi- | Embodi- |
| time (hr) | Embodiment 1-2 | | | Embodiment 2-2 | | | ment 3 | ment 4 | ment 5 |
| 0.0 | 0.00 | 0.00 | 0.00 | 0.00 | 0.00 | 0.00 | 0.00 | 0.00 | 0.00 |
| 0.5 | 98.20 | 97.30 | 100.00 | 99.20 | 87.00 | 84.60 | 99.25 | 94.00 | 93.00 |
| 1.0 | 99.20 | 94.10 | 100.00 | 92.30 | 87.20 | 99.00 | 99.85 | 80.00 | 19.00 |
| 1.5 | 99.30 | 94.80 | 100.00 | 94.15 | 86.70 | 100.00 | 99.85 | 76.00 | 16.00 |
| 2.0 | 99.35 | 95.20 | 100.00 | 94.00 | 86.30 | 100.00 | 99.85 | 60.00 | 16.50 |
| 2.5 | 99.40 | 95.60 | 100.00 | 94.85 | 86.10 | 100.00 | 99.85 | 41.00 | 17.50 |
| 3.0 | 99.45 | 95.70 | 100.00 | 94.70 | 87.00 | 100.00 | 99.85 | 38.00 | 17.50 |

From the hydrogen (H₂) removal rates calculated in Table 3, palladium (Pd) and platinum (Pt) showed substantially similar performance as catalysts for removing hydrogen. Particularly, when palladium (Pd) and nickel (Ni) were mixed, remarkably high hydrogen (H₂) removal performance could be exhibited.

In addition, as the support of the catalyst, aluminum oxide (Al₂O₃) was the most excellent, and cerium oxide (CeO₂) and yttrium oxide (Y₂O₃) were not preferable because cerium oxide (CeO₂) and yttrium oxide (Y₂O₃) produced a result of rather lowering the hydrogen (H₂) removal rate.

Particularly, during removal of hydrogen (H₂), when an initial concentration was 2.000 vol. %, the removal rate tended to be significantly lowered. Furthermore, when the initial concentration was 1.000 vol. %, generally better performance was shown than when the initial concentration was 2.000 vol. %. Furthermore, when the initial concentration was 0.5000 vol. %, complete removal of hydrogen (H₂) was confirmed to be possible.

TABLE 4

| | Oxygen removal rate (%) | | | | | | | | |
|---|---|---|---|---|---|---|---|---|---|
| Reaction | Embodi- | Embodi- | Embodi- | Embodi- | Embodi- | Embodi- | Embodi- | Embodi- | Embodi- |
| time (hr) | ment 1-1 | ment 1-2 | ment 1-3 | ment 2-1 | ment 2-2 | ment 2-3 | ment 3 | ment 4 | ment 5 |
| 0.0 | 0.00 | 0.00 | 0.00 | 0.00 | 0.00 | 0.00 | 0.00 | 0.00 | 0.00 |
| 0.5 | 99.28 | 97.92 | 96.93 | 99.97 | 99.97 | 99.75 | 99.97 | 99.95 | 99.96 |
| 1.0 | 99.98 | 99.97 | 99.97 | 99.97 | 99.96 | 99.78 | 99.97 | 99.99 | 99.98 |
| 1.5 | 99.98 | 99.97 | 99.98 | 99.98 | 99.96 | 99.74 | 99.98 | 99.98 | 99.98 |
| 2.0 | 99.99 | 99.97 | 99.98 | 99.97 | 99.97 | 99.67 | 99.98 | 99.98 | 99.98 |
| 2.5 | 99.98 | 99.97 | 99.97 | 99.98 | 99.97 | 99.62 | 99.98 | 99.99 | 99.98 |
| 3.0 | 99.98 | 99.98 | 99.98 | 99.98 | 99.96 | 99.63 | 99.98 | 99.98 | 99.98 |

Next, from the oxygen (O₂) removal rates calculated in Table 4, palladium (Pd) and platinum (Pt) showed substantially similar performance as catalysts for removing oxygen (O₂), and all Embodiments showed a very high removal rate of 99.9% or more. Here, particularly when palladium (Pd) and nickel (Ni) were mixed, removal of oxygen (O₂) proceeded remarkably rapidly, and the removal rate was also confirmed to be the highest.

In addition, as the support of the catalyst, aluminum oxide (Al₂O₃), cerium oxide (CeO₂), and yttrium oxide (Y₂O₃) showed substantially similar results, but aluminum oxide (Al₂O₃) showed the lowest performance, cerium oxide (CeO₂) showed an intermediate performance, and yttrium oxide (Y₂O₃) showed the highest removal rate and removal speed.

Although the present disclosure has been described through the specific matters and limited embodiments as described above, the specific matters and limited embodiments are provided only to help overall understanding of the present disclosure, and the present disclosure is not limited to the above-described embodiments. Various modifications and variations may be made from such description by one of ordinary skill in the art to which the present disclosure pertains.

Therefore, the scope of the present disclosure should not be determined as being limited to the described embodiments, and the claims described below, as well as all matters equivalent or equivalently modified to the claims, should be construed as falling within the scope of the present disclosure.

What is claimed is:

1. A water electrolysis system comprising:
a water electrolysis device;
a hydrogen (H₂) removal device; and
an oxygen (O₂) removal device,
wherein the water electrolysis device comprises an oxidation electrode (anode) and a reduction electrode (cathode),
wherein the hydrogen (H₂) removal device is configured to remove hydrogen (H₂) from an oxygen (O₂) stream generated from the oxidation electrode (anode) of the water electrolysis device,
wherein the oxygen (O₂) removal device is configured to remove oxygen (O₂) from a hydrogen (H₂) stream generated from the reduction electrode (cathode) of the water electrolysis device, and
wherein the hydrogen (H₂) removal device and the oxygen (O₂) removal device each comprise a catalyst.

2. The water electrolysis system of claim 1, wherein the catalyst comprises a catalytic metal and a support.

3. The water electrolysis system of claim 2, wherein the catalytic metal is at least one selected from palladium (Pd), platinum (Pt), nickel (Ni), silver (Ag), gold (Au), manganese (Mn), iron (Fe), cobalt (Co), zinc (Zn), ruthenium (Ru), rhodium (Rh), osmium (Os), iridium (Ir), lutetium (Lu), gallium (Ga), indium (In), bismuth (Bi), molybdenum (Mo), gadolinium (Gd), titanium (Ti), and copper (Cu).

4. The water electrolysis system of claim 2, wherein the support is at least one selected from the group consisting of oxides of aluminum (Al), cerium (Ce), manganese (Mn), indium (In), iridium (Ir), gallium (Ga), thallium (Tl), zinc (Zn), titanium (Ti), and yttrium (Y).

5. The water electrolysis system of claim 2, wherein a content of the catalytic metal in the catalyst is 0.1 wt % to 3.0 wt %.

6. The water electrolysis system of claim 1, wherein the hydrogen (H₂) removal device is configured to remove 99% or more of hydrogen (H₂) molecules from the oxygen (O₂) stream.

7. The water electrolysis system of claim 1, wherein the oxygen (O₂) removal device is configured to remove 99.99% or more of oxygen (O₂) molecules from the hydrogen (H₂) stream.

8. The water electrolysis system of claim 1, wherein, in the hydrogen (H₂) removal device, hydrogen (H₂) molecules are removed from the oxygen (O₂) stream within three hours.

9. The water electrolysis system of claim 1, wherein, in the oxygen (O₂) removal device, oxygen (O₂) molecules are removed from the hydrogen (H₂) stream within three hours.

10. The water electrolysis system of claim 1, wherein the hydrogen (H₂) removal device and the oxygen (O₂) removal device each comprise a catalytic reactor, a moisture adsorber, and a wool member.

11. The water electrolysis system of claim 1, wherein the water electrolysis system comprises:
a hydrogen (H₂) removal module formed of a plurality of hydrogen (H₂) removal devices; and
an oxygen (O₂) removal module formed of a plurality of oxygen (O₂) removal devices.

12. The water electrolysis system of claim 1, wherein the water electrolysis system comprises a plurality of hydrogen (H₂) removal devices and a plurality of oxygen (O₂) removal devices, and
wherein, while one hydrogen (H₂) removal device and one oxygen (O₂) removal device are in operation, the remaining hydrogen (H₂) removal devices and the remaining oxygen (O₂) removal devices perform a regeneration reaction of the catalyst.
